(19) United States
(12) Patent Application Publication
(10) Pub. No.: US 2012/0223463 A1
(43) Pub. Date: Sep. 6, 2012

(54) METHOD FOR VULCANIZING VEHICLE TIRES USING A HEATING PRESS

(75) Inventors: Milos KOVAC, Puchov (SK); Bernd FRICKE, Sehnde (DE)

(73) Assignee: CONTINENTAL REIFEN DEUTSCHLAND GMBH, Hannover (DE)

(21) Appl. No.: 13/410,966

(22) Filed: Mar. 2, 2012

Related U.S. Application Data
(63) Continuation of application No. PCT/EP2010/062361, filed on Aug. 25, 2010.

(30) Foreign Application Priority Data
Sep. 3, 2009 (DE) 102009043940.4

(51) Int. Cl. B29C 35/04; B29D 30/26

(52) U.S. Cl. 264/501; 425/50; 425/29

(57) ABSTRACT

Method and device for vulcanizing vehicle tires using a heating press and a heating bladder. The method includes positioning a tire blank in the heating press, feeding steam into the heating bladder, stopping the supply of steam into the heating bladder, raising an internal pressure in the heating bladder to a predetermined setpoint value by feeding nitrogen into the heating bladder, and consistently maintaining the internal pressure of the heating bladder at the predetermined setpoint value through a pulsating input of nitrogen into the heating bladder occurring at least temporarily over a specific time.

### CROSS-REFERENCE TO RELATED APPLICATIONS

The present application is a Continuation of International Patent Application No. PCT/EP2010/062361 filed Aug. 25, 2010, and claims priority under 35 U.S.C. §119 of German Patent Application No. 10 2009 043 940.4 filed Sep. 3, 2009. Moreover, the disclosure of International Patent Application No. PCT/EP2010/062361 is expressly incorporated by reference herein in its entirety.

### BACKGROUND OF THE INVENTION

1. Field of the Invention

The invention relates to a method and device for vulcanizing vehicle tires using a heating press.

2. Discussion of Background Information

The vulcanizing of tires is performed in heating presses in which the tire blank is inserted into suitable mold segments and vulcanized under the effect of heat and pressure. A flexible bladder is placed against the tire on the inside thereof and subjected to a vaporous heating medium, by means of which the necessary vulcanizing energy is supplied to the tire blank from the inside. Supplying the vulcanizing energy via the inside of the tire is referred to as internal heating. The required vulcanizing temperatures and vulcanizing time are dependent on various parameters, for example on the type of tire.

One problem when vulcanizing tires is that differences in temperature occur over the height in the bladder interior. As a result, the lower regions of the tire are heated more than the upper regions of the vehicle tire. The higher temperature in the lower half of the tire leads in particular to a reduction in the heating time. Furthermore, the differences in temperature over the height in the bladder interior can adversely influence the quality of the vehicle tires to be produced.

### SUMMARY OF THE EMBODIMENTS

Embodiments of the invention are directed to a method for vulcanizing vehicle tires that are produced with a high level of production quality.

Accordingly, embodiments of the method include:

a) arranging a tire blank in the heating press;

b) feeding steam into the heating bladder;

c) stopping the supply of steam to the heating bladder;

d) raising the internal pressure in the heating bladder to a predetermined setpoint value by feeding nitrogen by way of a nitrogen supply line;

e) keeping the internal pressure constantly at the predetermined setpoint value, a pulsating input of nitrogen into the heating bladder taking place at least temporarily over a specific time by way of opening and closing a valve in the nitrogen supply line for a short time, whereby a temperature stratification of the heating medium in the heating bladder is considerably reduced; and

f) completely vulcanizing the tire blank and removing the vehicle tire from the heating press.

Advantageously, the embodiments of the method largely avoid an undesired temperature stratification in the interior of the heating bladder. A pulsating supply of nitrogen into the interior of the heating bladder has the effect of permanently disturbing the formation of the temperature stratification. This repeatedly brings about a homogeneous mixing of the heating medium in the heating bladder. The pulsating or intermittent admission of nitrogen is realized by way of the nitrogen valve, which is repeatedly closed and opened again for a short time. Due to natural condensation, after the closing of the nitrogen valve, the internal pressure of the bladder drops within a short time. If the nitrogen valve is subsequently opened again, nitrogen flows at an increased flow rate into the interior of the bladder, which leads to a homogeneous mixing of the heating medium in the heating bladder. Consequently, the steady surge caused by the pulsating input of nitrogen permanently disturbs the formation of layers in the heating bladder and, therefore, leads to a more uniform homogeneous temperature distribution. In this way, a shortening of the vulcanizing time is achieved and, furthermore, the production quality of the vehicle tires to be produced is increased.

In an advantageous development of the embodiments, the pulsating input of nitrogen into the heating bladder takes place or results in a sawtooth-shaped pressure profile. The sawtooth-shaped pressure profile has a positive influence on the thorough mixing of the heating medium in the heating bladder.

In a further advantageous development of the embodiments, the pulsating input of nitrogen is achieved by opening the valve of the nitrogen supply line again after a detected pressure drop in the heating bladder of about 0.5 to about 1 bar, until the internal pressure subsequently rises again to the predetermined setpoint value. This effectively produces in the heating bladder a pulsating or intermittent pressure profile, which effectively reduces the temperature stratification in the heating bladder.

In a further advantageous development of the embodiments, the pulsating input of nitrogen into the heating bladder takes place until the end of the vulcanizing time of the tire blank. As a result, the temperature stratification in the heating bladder is reduced over the entire vulcanizing time.

In a further advantageous development of the embodiments, the nitrogen supply line and the steam supply line are arranged parallel to one another and open out into a common line to the heating bladder. This allows a pulsating input of nitrogen into the heating bladder to be realized in a simple way.

In a further advantageous development of the embodiments, the steam in step b) has a steam pressure in the range between 15 and 18 bar. With these steam pressure values, an optimum input of energy can be achieved.

In a further advantageous development of the embodiments, the nitrogen has a predetermined pressure value in the range between 20 and 30 bar. With these pressure values, an optimum input of energy takes place by way of the heating medium.

Embodiments of the invention are directed to a method for vulcanizing vehicle tires using a heating press and a heating bladder. The method includes positioning a tire blank in the heating press, feeding steam into the heating bladder, stopping the supply of steam into the heating bladder, raising an internal pressure in the heating bladder to a predetermined setpoint value by feeding nitrogen into the heating bladder, and consistently maintaining the internal pressure of the heating bladder at the predetermined setpoint value through a pulsating input of nitrogen into the heating bladder occurring at least temporarily over a specific time.

According to embodiments, the method can also include completing a vulcanizing the tire blank and removing the vehicle tire from the heating press.

In accordance with other embodiments of the instant invention, the pulsating input of nitrogen into the heating bladder can include opening and closing a valve in a nitrogen supply line for a short time.

According to still other embodiments, the pulsating input of nitrogen into the heating bladder reduced a temperature stratification of the heating medium in the heating bladder.

In accordance other embodiments, as a result of the pulsating input of nitrogen into the heating bladder, a sawtooth-shaped pressure profile can arise within the heating bladder. The pulsating input of nitrogen into the bladder can include opening the valve in the nitrogen supply line when a pressure drop of between about 0.5 to 1.0 bar is detected in the heating bladder until the internal pressure subsequently rises again to the predetermined setpoint value.

According to still other embodiments of the invention, the pulsating input of nitrogen into the heating bladder continues until an end of the vulcanizing time of the tire blank.

Further, the nitrogen supply line and the steam supply line are arranged parallel to one another and open into a common line coupled to the heating bladder.

According to other embodiments, the steam can be fed into the bladder interior to exert a steam pressure in a range between 15 and 18 bar. Still further, the nitrogen can be fed into the bladder interior to exert the predetermined pressure value in a range between 20 and 30 bar.

Embodiments of the instant invention are directed to a vulcanizing device for vulcanizing a tire blank. The vulcanizing device includes a heating press structured and arranged to receive a heating bladder, a steam supply line coupled to the heating bladder having a steam valve structured and arranged to open and close a supply of steam into the heating bladder, and a nitrogen supply line coupled to the heating bladder having a nitrogen valve structured and arranged to open and close a supply of nitrogen into the heating bladder.

According to other embodiments of the invention, the steam supply line and nitrogen supply line may be arranged in parallel and connected to a common line connected to the heating press.

Further, the vulcanizing device may also include a controller structured and arranged to monitor an internal pressure within the heating bladder and to control the nitrogen valve in accordance with the monitored internal pressure. The may be further structured and arranged to control the steam valve in accordance with the monitored internal pressure. Further, the controller may also be further structured and arranged to exert a steam pressure of between 15 bar and 18 bar. The controller can also be structured and arranged to maintain the steam pressure for a first 5-10 minutes of vulcanizing time. Moreover, after maintaining the stream pressure for the first 5-10 minutes, the controller may be further structured and arranged to exert a consistent pressure of between 20 bar and 30 bar for a remaining vulcanizing time via an intermittent supply of nitrogen to the heating bladder.

According to still other embodiments, the controller can be further structured and arranged to exert a consistent pressure of between 20 bar and 30 bar. The consistent pressure may exhibit a saw-toothed pressure profile.

In accordance with still yet other embodiments of the present invention, when the internal pressure monitored by the controller drops between 0.5 bar and 1.0 bar from a predefined pressure, the controller opens the nitrogen valve to increase the internal pressure in the heating bladder to the predefined pressure.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a heating press with a tire blank;

FIG. 2 shows a steam pressure curve in accordance with the method; and

FIG. 3 shows a conventional steam pressure curve.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

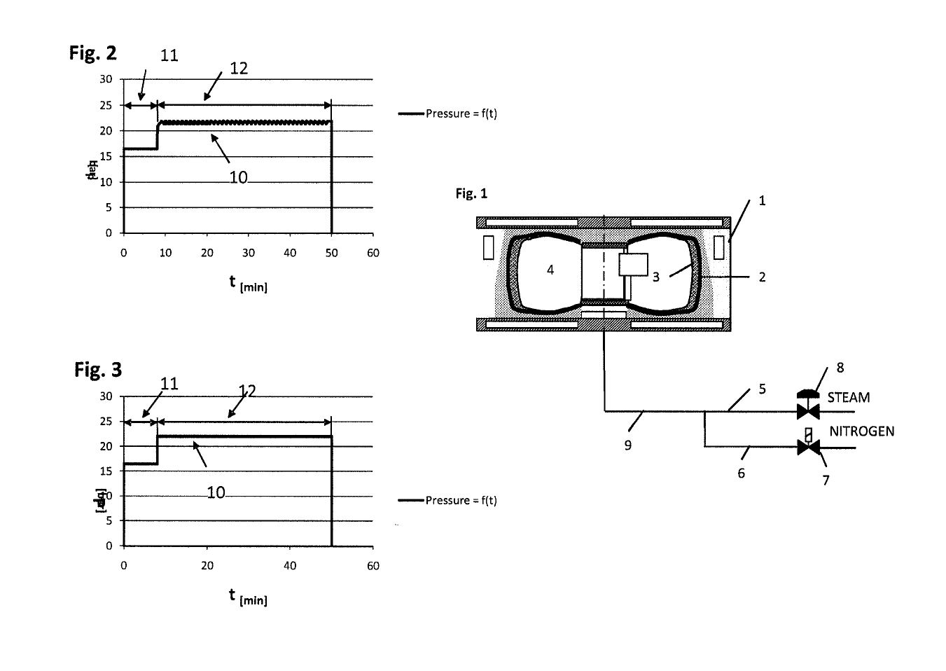

FIG. 1 shows a heating press 1 with a tire blank 2. A heating bladder 3 is arranged on an inner side of tire blank 2 and a heating medium by which heating energy is supplied from the inner side is introduced into interior 4. The supply of steam into bladder cavity 4 is provided via steam supply line 5. The supply of steam can be controlled by way of valve 8 in steam supply line 5. The supply of nitrogen takes place by way of a nitrogen supply line 6 with a valve 7. Intermittent opening and closing of valve 7 in nitrogen supply line 5 produces a pulsating or intermittent input of nitrogen into heating bladder 3. Steam supply line 5 and nitrogen supply line 6 are arranged parallel to one another and open out into a common supply line 9, which opens out into heating bladder 3.

With a steam-nitrogen internal heating method according to the embodiments, the energy required for vulcanizing is introduced substantially by way of a steam phase, which flows first into bladder interior 4. After a certain time, e.g., between 5 and 10 minutes, the supply of steam through valve 8 is stopped. Subsequently, the internal pressure in bladder interior 4 is raised by introducing nitrogen via nitrogen supply line 6 and is kept substantially constant through a subsequent intermittent or pulsating input of nitrogen. The intermittent or pulsating input of nitrogen by way of valve 7 considerably reduces the formation of a temperature stratification in heating bladder 3. The intermittent or pulsating admission of nitrogen is achieved by closing and opening valve 7 for a short time. Due to natural condensation, when valve 7 in nitrogen supply line 6 is closed, the internal bladder pressure drops. After reaching a threshold (low) value, valve 7 is opened again so the nitrogen flows at an increased flow rate into bladder interior 4, until a predefined threshold (high) value is achieved. This steady surge caused by the pulsating input of nitrogen disturbs the formation of layers in the bladder cavity 4 and thereby leads to a more uniform temperature distribution.

FIG. 2 shows a pressure profile 10 in heating bladder 3 when the method according to the embodiments is used. The vulcanizing time t is plotted in minutes on the x axis, while the value of the pressure p in heating bladder 3 is plotted in bar on the y axis. During vulcanizing time 11, heating is performed exclusively via a steam phase at a pressure between 15 and 18 bar, preferably 16.5 bar. After approximately 5 to 10 minutes, the supply of steam is stopped and the internal pressure is raised to a pressure level between 20 and 24 bar, preferably about 22 bar, by supplying nitrogen. During vulcanizing time 12, the pulsating input of nitrogen according to the method is achieved by opening and closing valve 7 in nitrogen supply line 6.

This produces a pressure profile of an oscillating form, as illustrated in FIG. 2, which significantly reduces the temperature stratification in heating bladder 3. The pressure profile is substantially sawtooth-shaped. After a detected pressure drop in heating bladder 3 of about 0.5 to about 1 bar, valve 7 of nitrogen supply line 6 is opened again, so that the internal pressure subsequently rises again to the predetermined setpoint value, which is between 20 and 24 bar, and preferably about 22 bar. Such a pulsating input of nitrogen can be realized by way of a connected computer control, which automatically controls the opening and closing of valve 8 in steam supply line 5. The method according to the embodiments has the effect of shortening the vulcanizing time and, at the same time, enables the production of vehicle tires with a high level of production quality.

FIG. 3 shows a conventional steam pressure curve 10, with no pulsating input of nitrogen, as is known from the prior art.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF DESIGNATIONS

(is part of the description)
1 heating press
2 tire blank
3 heating bladder
4 bladder cavity
5 steam supply line
6 nitrogen supply line
7 valve of the nitrogen supply line
8 valve of the steam supply line
9 common supply line
10 pressure profile in the heating bladder
11 vulcanizing time during which heating is performed just with steam
12 vulcanizing time during which nitrogen is added
P pressure in the heating bladder
t vulcanizing time in minutes

What is claimed:

1. A method for vulcanizing vehicle tires using a heating press and a heating bladder, the method comprising:
positioning a tire blank in the heating press;
feeding steam into the heating bladder;
stopping the supply of steam into the heating bladder;
raising an internal pressure in the heating bladder to a predetermined setpoint value by feeding nitrogen into the heating bladder; and
consistently maintaining the internal pressure of the heating bladder at the predetermined setpoint value through a pulsating input of nitrogen into the heating bladder occurring at least temporarily over a specific time.

2. The method in accordance with claim 1, further comprising:
completing a vulcanizing the tire blank; and
removing the vehicle tire from the heating press.

3. The method in accordance with claim 1, wherein the pulsating input of nitrogen into the heating bladder comprises opening and closing a valve in a nitrogen supply line for a short time.

4. The method in accordance with claim 1, wherein the pulsating input of nitrogen into the heating bladder reduced a temperature stratification of the heating medium in the heating bladder.

5. The method in accordance with claim 1, wherein, as a result of the pulsating input of nitrogen into the heating bladder, a sawtooth-shaped pressure profile arises within the heating bladder.

6. The method in accordance with claim 5, wherein the pulsating input of nitrogen into the bladder comprises opening the valve in the nitrogen supply line when a pressure drop of between about 0.5 to 1.0 bar is detected in the heating bladder until the internal pressure subsequently rises again to the predetermined setpoint value.

7. The method in accordance with claim 1, wherein the pulsating input of nitrogen into the heating bladder continues until an end of the vulcanizing time of the tire blank.

8. The method in accordance with claim 1, wherein the nitrogen supply line and the steam supply line are arranged parallel to one another and open into a common line coupled to the heating bladder.

9. The method in accordance with claim 1, wherein the steam is fed into the bladder interior to exert a steam pressure in a range between 15 and 18 bar.

10. The method in accordance with claim 1, wherein the nitrogen is fed into the bladder interior to exert the predetermined pressure value in a range between 20 and 30 bar.

11. A vulcanizing device for vulcanizing a tire blank, comprising:
a heating press structured and arranged to receive a heating bladder;
a steam supply line coupled to the heating bladder having a steam valve structured and arranged to open and close a supply of steam into the heating bladder; and
a nitrogen supply line coupled to the heating bladder having a nitrogen valve structured and arranged to open and close a supply of nitrogen into the heating bladder.

12. The vulcanizing device in accordance with claim 11, wherein the steam supply line and nitrogen supply line are arranged in parallel and connected to a common line connected to the heating press.

13. The vulcanizing device in accordance with claim 11, further comprising a controller structured and arranged to monitor an internal pressure within the heating bladder and to control the nitrogen valve in accordance with the monitored internal pressure.

14. The vulcanizing device in accordance with claim 13, wherein the controller is further structured and arranged to control the steam valve in accordance with the monitored internal pressure.

15. The vulcanizing device in accordance with claim 14, wherein the controller is further structured and arranged to exert a steam pressure of between 15 bar and 18 bar.

16. The vulcanizing device in accordance with claim 15, wherein the controller is further structured and arranged to maintain the steam pressure for a first 5-10 minutes of vulcanizing time.

17. The vulcanizing device in accordance with claim 16, wherein, after maintaining the stream pressure for the first 5-10 minutes, the controller is further structured and arranged to exert a consistent pressure of between 20 bar and 30 bar for a remaining vulcanizing time via an intermittent supply of nitrogen to the heating bladder.

18. The vulcanizing device in accordance with claim 13, wherein the controller is further structured and arranged to exert a consistent pressure of between 20 bar and 30 bar.

19. The vulcanizing device in accordance with claim 18, wherein the consistent pressure exhibits a saw-toothed pressure profile.

20. The vulcanizing device in accordance with claim 13, wherein, when the internal pressure monitored by the controller drops between 0.5 bar and 1.0 bar from a predefined pressure, the controller opens the nitrogen valve to increase the internal pressure in the heating bladder to the predefined pressure.
